(19) United States
(12) Patent Application Publication
(10) Pub. No.: US 2025/0320733 A1
(43) Pub. Date: Oct. 16, 2025

(54) AUTONOMOUS POWER TROWEL SYSTEM

(71) Applicant: UltraTrowel, Herriman, UT (US)

(72) Inventor: William Cooke, Herriman, UT (US)

(73) Assignee: UltraTrowel, Herriman, UT (US)

(21) Appl. No.: 18/632,834

(22) Filed: Apr. 11, 2024

(51) Int. Cl. E04F 21/24; G05D 1/246; G05D 1/43; G05D 105/05

(52) U.S. Cl. CPC E04F 21/245; G05D 1/246; G05D 1/43; G05D 2105/05

(57) ABSTRACT

A trowel system for finishing a concrete floor is disclosed. The system may include a first rotor and a second rotor configured to axially rotate at a same speed in opposite directions. The system may further include a sensor unit configured to detect a concrete floor boundary or a presence of an obstacle on the floor when the system moves on the floor. The system may further include a processor configured to activate a first rotor rotation and a second rotor rotation, and obtain inputs from the sensor unit responsive to activating the first rotor rotation and the second rotor rotation. The processor may further generate a concrete floor two-dimensional (2D) map based on the inputs obtained from the sensor unit, and control a first rotor operation and a second rotor operation to cause a system movement on the floor based on the concrete floor 2D map.

### TECHNICAL FIELD

The present disclosure relates to a power trowel system, and more particularly, to a power trowel system configured to generate a two-dimensional (2D) map of a concrete floor and autonomously control a trowel system movement on the concrete floor based on the 2D map.

### BACKGROUND

It is known that a construction contractor performs a plurality of actions to “finish” a concrete floor job and obtain a desired texture of a wet concrete floor. The contractor may perform the finishing actions by hand or by using a machine. For example, the contractor may employ one or more users who may use a hand trowel to smoothen the wet concrete surface and achieve the desired texture.

Smoothening or finishing the concrete floor by using the hand trowel is a time-consuming process. Further, implementing such a process requires presence of skilled individuals having expertise in concrete finishing, who may not be readily available. Furthermore, smoothening the concrete floor by using the hand trowel is a labor-intensive task, which may cause inconvenience to the users. Furthermore, finishing a floor by hand may leave many inconsistencies and may not yield a hard enough “glass like” finish.

While conventional power trowel systems or machines assist the contractor in effectively finishing the concrete floor, such machines are typically bulky and complex to operate. Due to their bulky structure and large size, the conventional power trowel systems have limited utility in finishing concrete floors of smaller sizes, e.g., floors of residential buildings or small office spaces. Further, presence of skilled operators is required on the field continuously to operate the conventional power trowel systems. Hiring such skilled operators may be expensive, and their availability may also be limited.

Thus, a system is required that enables a user to conveniently and efficiently finish a concrete floor, especially a concrete floor of small size.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a front view of an example power trowel system in accordance with the present disclosure.

FIG. 3 depicts a side view of an example power trowel system in accordance with the present disclosure.

FIG. 4 depicts a front view of an example power trowel system showing rotors in a first configuration in accordance with the present disclosure.

FIG. 5 depicts a front view of an example power trowel system showing rotors in a second configuration in accordance with the present disclosure.

FIG. 6 depicts a front view of an example power trowel system showing rotors in a third configuration in accordance with the present disclosure.

FIG. 7 depicts a front view of an example power trowel system showing rotors in a fourth configuration in accordance with the present disclosure.

FIG. 8A depicts an isometric view of a plurality of blades of an example power trowel system in a first configuration in accordance with the present disclosure.

FIG. 8B depicts an isometric view of a plurality of blades of an example power trowel system in a second configuration in accordance with the present disclosure.

FIGS. 9A and 9B depict a flow diagram of an example trowel method for finishing a concrete floor in accordance with the present disclosure.

### DETAILED DESCRIPTION

### Overview

The present disclosure describes an autonomous power trowel system (“system”) configured to autonomously “finish” or smoothen a concrete floor. The system may include a first rotor and a second rotor that may be configured to axially rotate at same speeds, but in opposite directions. The system may further include a first set of blades connected to the first rotor, and a second set of blades connected to the second rotor. The first and second sets of blades may contact and smoothen the concrete floor, when the system is placed on the concrete floor and the first and second rotors are activated to axially rotate. In some aspects, the system may autonomously finish the concrete floor such that all floor areas/sections are evenly smoothened by the first and second sets of blades.

In some aspects, the system may further include a sensor unit that may be configured to detect a concrete floor boundary and/or a presence of an obstacle on the concrete floor when the system moves on the concrete floor. The system may be configured to generate a concrete floor two-dimensional (2D) map based on inputs obtained from the sensor unit, and control a first rotor operation and a second rotor operation based on the generated floor 2D map. Specifically, when a contractor/user places the system on the concrete floor, the system may cause initial system movement on the floor. Responsive to causing the initial system movement, the system may obtain the inputs from the sensor unit to generate the floor 2D map.

In an exemplary aspect, the system may further include a plurality of actuators or servo motors that may enable the system to move forward/backward, take left or right turn, slide side-to-side, and/or alter blade pitch relative to the concrete floor. As an example, the system may include a first set of actuators that may be configured to control/alter an angle between a first rotor plane and a second rotor plane relative to the concrete floor. The system may be configured to cause the system's forward or backward movement or cause the system to turn left or right by causing the first set of actuators to alter the angle between the first rotor plane and the second rotor plane relative to the concrete floor, when the first and second rotors may be rotating and the system may be placed on the floor. As another example, the system may include a second set of actuators that may enable the system to cause the system's side-to-side sliding movement. As yet another example, the system may include a third set of actuators that may enable the system to alter the blade's pitch relative to the concrete floor.

In some aspects, the system may activate or control operation of the first and second sets of actuators such that the system moves on the entire floor area and the blades evenly smoothen each floor section (and one floor section is not smoothened more or less than the other floor sections). The system may further activate or control operation of the third set of actuators to alter the blade's pitch, such that the blades effectively smoothen the floor based on the user's preferences, environmental conditions, or inputs associated with the floor's desired smoothness level, shine, etc.

In some aspects, the system may additionally enable the user to control the system's movement on the floor by using a user device or a remote controller.

The present disclosure discloses an autonomous power trowel system that may effectively finish or smoothen a wet concrete floor, without requiring human intervention (or requiring minimal human intervention). The system may autonomously finish the concrete floor such that all floor areas or sections are evenly smoothened, and the system covers the entire floor area. The system may further enable the user to remotely control the system's operation via the user device or the remote controller, thereby enhancing the system's ease of operation. Furthermore, the system is compact and lightweight, and can be effectively used to finish concrete floors of residential buildings or small office spaces.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

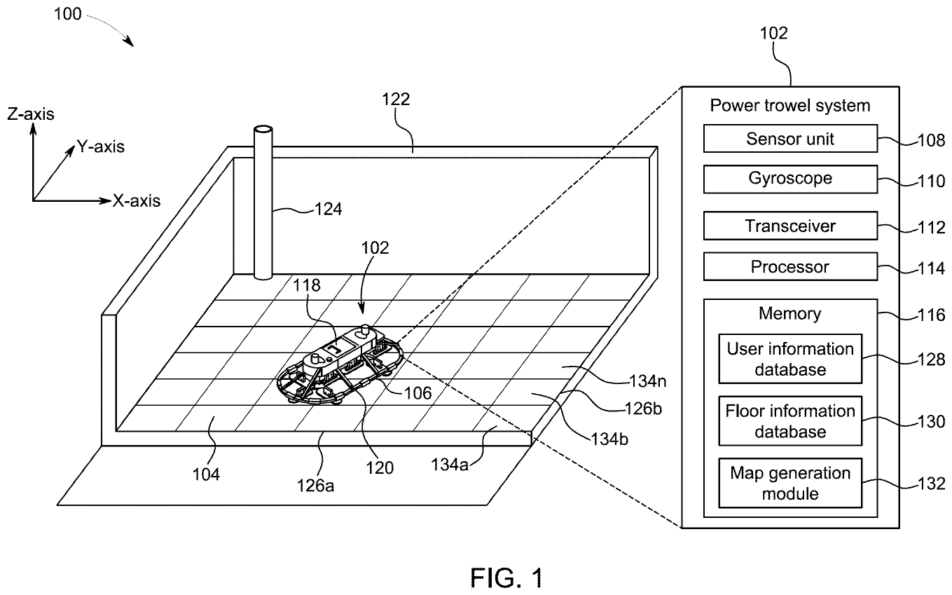

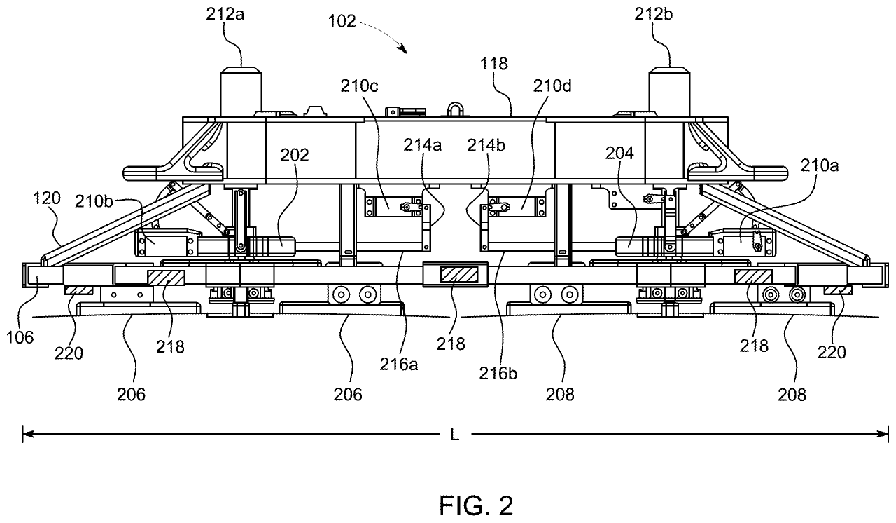

FIG. 1 depicts an example environment 100 in which techniques and structures for providing the systems and methods disclosed herein may be implemented. FIG. 1 will be described in conjunction with FIGS. 2-7, 8A and 8B.

The environment 100 may include an autonomous power trowel system 102 (or system 102) that may be configured to move on a wet concrete floor 104, and “finish” or smoothen the floor 104. The floor 104 may be disposed on an X-Y plane, as shown in FIG. 1. The floor 104 may be located in a residential building, an office space, or a commercial building that may be under-construction or undergoing renovation. In some aspects, the system 102 may autonomously control a system movement on the floor 104 to ensure that all areas/sections of the floor 104 are evenly finished/smoothened according to user/owner's preferences (e.g., preferences associated with a floor surface shine, a smoothness level, etc.). In other aspects, the system movement may be controlled by an operator (e.g., a construction contractor, not shown) via a user device or a remote controller (not shown). In this case, the system 102 may be communicatively coupled with the user device or the remote controller via a wireless network.

The wireless network described above may be, for example, a communication infrastructure in which the connected devices discussed in various embodiments of this disclosure may communicate. The wireless network may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

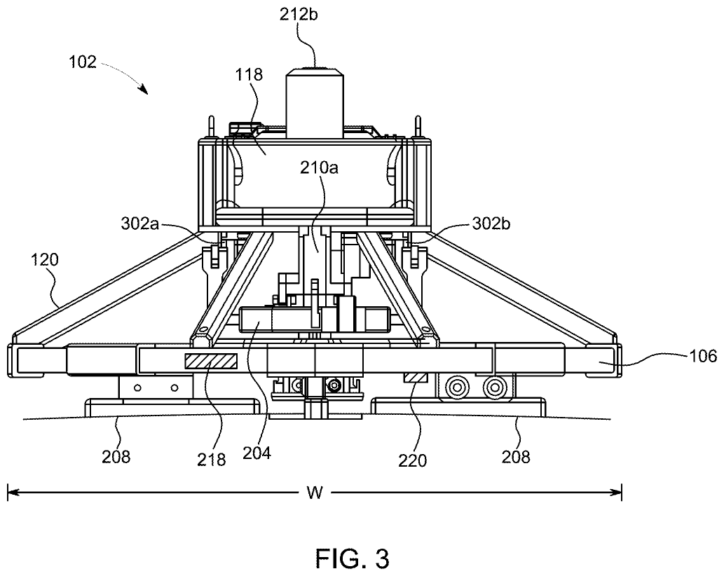

The system 102 may include a plurality of components/units including, but not limited to, a frame 106, a sensor unit 108, a gyroscope 110, a transceiver 112, a processor 114, a memory 116, a body 118, a first rotor 202 (as shown in FIG. 2), a second rotor 204, a first set of blades 206, a second set of blades 208, a plurality of actuators 210a, 210b, 210c, 210d, 302a, 302b (as shown in FIGS. 2 and 3), and/or the like, which may be electrically, communicatively and/or mechanically coupled with each other.

In some aspects, the body 118 may be an enclosure or a housing that may enclose/house one or more system components/units and protect them from ambient environment. For example, the system components such as the gyroscope 110, the transceiver 112, the processor 114, the memory 116, etc. may be housed in the body 118. The body 118 may be made of aluminum, stainless steel, plastic, or any other material. The body 118 may be of any shape. In the exemplary aspect depicted in FIG. 1, the body 118 is shown to be of an elongated oval or rectangular shape; however, such a body shape should not be construed as limiting.

The body 118 may be mechanically coupled with the frame 106, e.g., via one or more support bars 120. The frame 106 may have a rectangular shape or an elongated oval shape similar to the body's shape (as shown in FIG. 1). In some aspects, a frame length “L” (as shown in FIG. 2) may be in a range of 45 to 55 inches, and a frame width “W” (as shown in FIG. 3) may be in a range of 20 to 30 inches. A body length may be smaller than the frame length “L” (e.g., in a range of 30-80% of the frame length “L”), and a body width may also be substantially smaller than the frame width “W” (e.g., in a range of 20-50% of the frame width “W”). Further, the frame 106 may be made of the same or different material as the body 118.

The system 102 may additionally include one or more motors (which may be electric brushless motors, not shown) that may drive rotatory motions of the first and second rotors 202, 204. The motor(s) may also be housed in the body 118, and may be electrically and mechanically coupled with the first and second rotors 202, 204. Since the motors are housed in the body 118 and the motors are mechanically coupled with the first and second rotors 202, 204, the first and second rotors 202, 204 are also mechanically coupled with the body 118. Stated another way, the first and second rotors 202, 204 are mechanically coupled with the body 118 via the motors housed in the body 118.

In some aspects, the first rotor 202 and the second rotor 204 may be configured to axially rotate at a same speed and in opposite directions. For example, the first rotor 202 may rotate in a clockwise direction, and the second rotor 204 may rotate in a counterclockwise direction at the same speed. Conversely, the first rotor 202 may rotate in the counterclockwise direction, and the second rotor 204 may rotate in the clockwise direction at the same speed. In an exemplary aspect, a maximum rotor speed associated with the first and second rotors 202, 204 may be in a range of 0 to 200 rotations per minute (rpm). The motor(s) housed in the body 118 may drive the rotatory motions of the first and second rotors 202, 204 and control their rotation direction, rotation speed, etc. via gearboxes 212a, 212b connected to respective first and second rotors 202, 204 and command signals received from the processor 114, the user device and/or the remote controller.

The aspect described here wherein the motors are housed in the body 118 and the system 102 includes the gearboxes 212a, 212b is exemplary in nature, and should not be construed as limiting. In some aspects, the motors that drive the rotatory motions of the first and second rotors 202, 204 may be housed outside the body 118 (and may be externally connected to the body 118), without departing from the present disclosure scope. In another aspect, the system 102 may not include the gearboxes 212a, 212b, and the rotor speeds may be controlled via other means. Furthermore, in some aspects, the system 102 may include two separate motors, one each for the first rotor 202 and the second rotor 204. In other aspects, the system 102 may include a single motor, which may drive the rotatory motion of the first and second rotors 202, 204 simultaneously at the same speed and in opposite directions.

The first set of blades 206 may be connected/attached to the first rotor 202, and the second set of blades 208 may be connected/attached to the second rotor 204. The first set of blades 206 may be configured to rotate when the first rotor 202 rotates, and the second set of blades 208 may be configured to rotate when the second rotor 204 rotates. The first and second sets of blades 206, 208 rotate at the same speed as the first and second rotors 202, 204, and in the same direction as the respective first and second rotors 202, 204. In some aspects, a count of blades in the first set of blades 206 may be same as a count of blades in the second set of blades 208. In an exemplary aspect, the first set of blades 206 may include four blades, and the second set of blades 208 may also include four blades, although the present disclosure is not limited to such an aspect. In other aspects, the first and second sets of blades 206, 208 may include more or less than four blades.

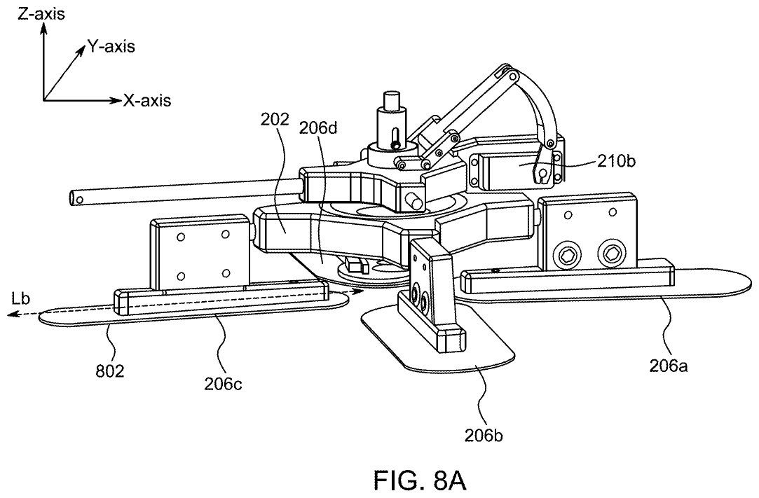

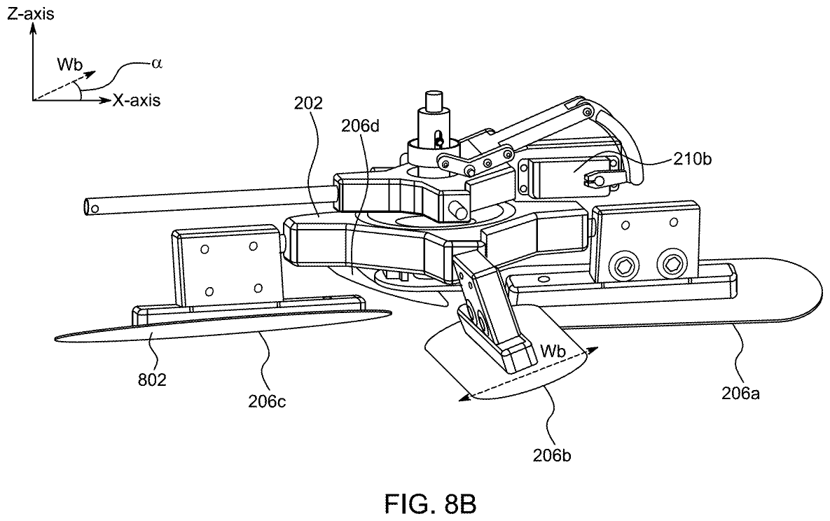

A detailed view of the first set of blades 206 and the first rotor 202 is shown in FIGS. 8A and 8B. The second set of blades 208 and the second rotor 204 have the same shape, arrangement, dimensions, etc. as the first set of blades 206 and the first rotor 202 respectively, and hence their detailed view is not depicted in FIGS. 8A and 8B. Although the description below for FIGS. 8A and 8B is associated with the first set of blades 206 and the first rotor 202, the same description and blade/rotor details will be applicable for the second set of blades 208 and the second rotor 204.

As shown in FIG. 8A, the first set of blades 206 may include four blades, i.e., a first blade 206a, a second blade 206b, a third blade 206c and a fourth blade 206d. Each blade 206 may be made of aluminum, stainless steel, plastic, a combination thereof, and/or the like. Further, each blade 206 may be shaped as or may be a rectangular plate or an elongated oval shaped plate, as shown in FIG. 8A. In an exemplary aspect, each blade 206 may have a blade length in a range of 10 to 12 inches, and a blade width in a range of 4 to 6 inches.

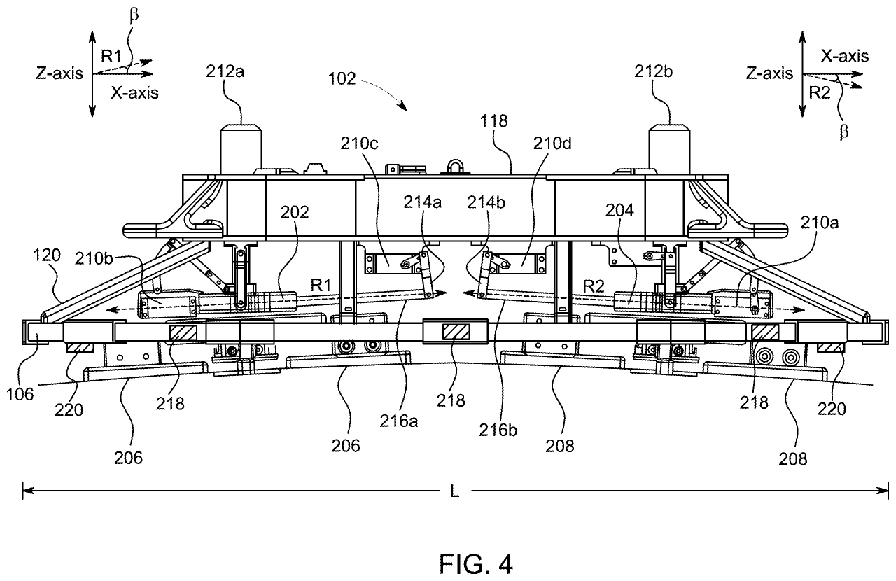

In some aspects, each blade 206 may be attached to the first rotor 202 such that a blade longitudinal axis “Lb” (as shown in FIG. 8A) may always be aligned with or be parallel to a first rotor plane (shown as first rotor plane “R1” in FIGS. 4-7). As an example, if the first rotor 202 is aligned parallel to the floor 104, the first rotor plane may be aligned with the X-Y plane (i.e., the plane of the floor 104). In this case, the blade longitudinal axis “Lb” may also be aligned with or be part of the X-Y plane. Stated another way, in this case, the blade longitudinal axis “Lb” may not be in the Z-axis. On the other hand, if the first rotor 202 is moved such that the first rotor plane gets inclined relative to the X-Y plane (as will be described later in the description below), the blade longitudinal axis “Lb” may also get inclined relative to the X-Y plane at the same angle as the first rotor plane.

In a similar manner as described above, each blade 208 may be attached to the second rotor 204 such that a blade longitudinal axis of each blade 208 (not shown) may always be aligned with or be parallel to a second rotor plane (shown as second rotor plane “R2” in FIGS. 4-7).

The first set of blades 206 and the second set of blades 208 may be configured to contact and smoothen the concrete floor surface when the first set of blades 206 and the second set of blades 208 rotate (i.e., when the first and second rotors 202, 204 rotate). Specifically, when the system 102 rests on the floor 104 (as shown in FIG. 1), a blade bottom surface 802 (shown in FIGS. 8A and 8B) and/or one or more blade edges of each blade 206, 208 may contact the concrete floor surface. In this configuration, when the first and second rotors 202, 204 are activated and caused to rotate (e.g., via the motor(s) housed in the body 118), each blade 206, 208 rotates, thereby causing the wet concrete floor surface of the floor 104 to smoothen.

In some aspects, depending on the user preferences associated with the required texture of the floor 104 (e.g., the desired smoothness level, shine level, etc. associated with the floor 104) and/or real-time floor conditions (e.g., real-time wetness level, smoothness level, etc.), each blade pitch may be altered/modified by the actuators 210a, 210b. In an exemplary aspect, the actuators 210a, 210b may be servo motors that may operate based on command signals obtained from the processor 114, the user device and/or the remote controller.

A blade pitch may be defined as an angle “a” between a blade lateral axis “Wb” and the rotor plane, as shown in FIG. 8B. In some aspects, the blade pitch or the angle “a” may be zero when the blade lateral axis “Wb” may be aligned parallel to the first rotor plane, as shown in FIG. 8A. In this configuration, when the first rotor plane may be aligned with the X-Y plane (e.g., the floor plane) and the system 102 rests on the floor 104, an entire blade bottom surface 802 may contact the concrete floor surface. When the first and second rotors 202, 204 may be caused to axially rotate in this configuration, the entire blade bottom surface 802 may contact and smoothen the concrete floor surface when the blades 206, 208 rotate.

On the other hand, the blade pitch or the angle “a” may be non-zero when the blade lateral axis “Wb” may not be aligned parallel to the first rotor plane, as shown in FIG. 8B. In this case, in an exemplary aspect, the angle “a” may be between 1 to 35 degrees. In this configuration, one of the blade edges along the blade length may contact the concrete floor surface (and not the entire blade bottom surface 802), when the first rotor plane may be aligned with the X-Y plane (e.g., the floor plane) and the system 102 rests on the floor 104. When the first and second rotors 202, 204 may be caused to axially rotate in this configuration, the blade edges that are in contact with the concrete floor surface may smoothen the floor surface when the blades 206, 208 rotate.

In some aspects, the actuator 210b may be connected to the first rotor 202, and configured to control/modify the angle “a” between the blade lateral axis “Wb” of each blade 206 and the first rotor plane, based on the command signals obtained from the processor 114, the user device and/or the remote controller. Stated another way, the actuator 210b may be configured to control/modify a blade pitch of each blade 206 based on the command signals obtained from the processor 114, the user device and/or the remote controller. In some aspects, the actuator 210b may control/modify the blade pitch such each blade 206 may be inclined at the same angle “a” relative to the first rotor plane.

In a similar manner, the actuator 210a may be connected to the second rotor 204, and configured to control/modify an angle (not shown) between a blade lateral axis of each blade 208 and the second rotor plane, based on the command signals obtained from the processor 114, the user device and/or the remote controller. Stated another way, the actuator 210a may be configured to control/modify a blade pitch of each blade 208 based on the command signals obtained from the processor 114, the user device and/or the remote controller. In some aspects, the actuator 210a may control/modify the blade pitch such each blade 208 may be inclined at the same angle relative to the second rotor plane. Further, in some aspects, the actuators 210a, 210b may be synced with each other such that the blade pitch of each blade 206 may be equivalent to the blade pitch of each blade 208.

In some aspects, the system 102 may remain stationary on the floor 104 when the first rotor 202 and the second rotor 204 rotate, and when the first rotor plane and the second rotor plane are aligned with the floor 104 (i.e., when the first rotor plane and the second rotor plane are aligned with the X-Y plane). On the other hand, the system 102 may be configured to move on the floor 104 when the first rotor 202 and the second rotor 204 rotate, and when at least one of the first rotor plane or the second rotor plane may be aligned at a non-zero angle relative to the floor 104 (i.e., when the first rotor plane and/or the second rotor plane may be aligned at a non-zero angle relative to the X-Y plane). In some aspects, the system 102 may move forward, backward, or turn left or right, based on the alignment angle of the first rotor plane and/or the second rotor plane relative to the floor 104/X-Y plane.

For example, as shown in FIG. 4, the system 102 may move in a first direction (which may be a backward direction, e.g., into the plane of the drawing depicted in FIG. 4) when a first rotor plane “R1” may be inclined at a non-zero angle “β” relative to the floor 104/X-Y plane (e.g., inclined at the angle “β” towards positive Z-axis), and a second rotor plane “R2” may be inclined at the angle “β” relative to the floor 104/X-Y plane towards negative Z-axis. In this case, when the first and second rotors 202, 204 rotate (causing the first and second sets of blades 206, 208 to rotate), the pressure and weight of each rotating blade 206, 208 may cause more friction on one side of the system 102 (relative to the other side) due to blade's contact with the floor surface, causing the system 102 to move in the backward direction. The example of the backward direction described above should not be construed as limiting. The first direction may be a forward direction based on whether the first rotor 202 is rotating in the clockwise direction or the counterclockwise direction (or whether the first rotor 202 is rotating in the counterclockwise direction or the clockwise direction).

In some aspects, the actuator 210c may be connected with the first rotor 202 via a lever system 214a and a shaft 216a, and may be configured to control/modify the angle “β” between the first rotor plane “R1” and the floor 104/X-Y plane based on command signals obtained from the processor 114, the user device and/or the remote controller. In a similar manner, the actuator 210d may be connected with the second rotor 204 via a lever system 214b and a shaft 216b, and may be configured to control/modify the angle “β” between the second rotor plane “R2” and the floor 104/X-Y plane based on the command signals obtained from the processor 114, the user device and/or the remote controller. As an example, when the system 102 is required to be moved in the backward direction, the actuators 210c, 210d may cause the first and second rotor planes “R1”, “R2” to be inclined at the angle “β” in the configuration/arrangement shown in FIG. 4 (e.g., by causing movement of the lever systems 214a, 214b, thereby causing movement of the shafts 216a, 216b to align the first and second rotors planes “R1”, “R2” at the required angle “β”).

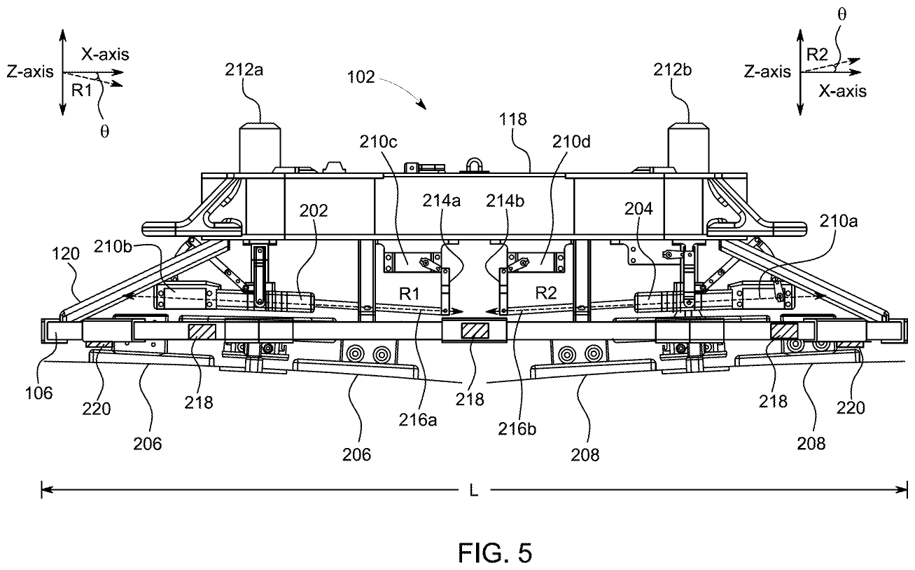

In a similar manner, when the system 102 is required to be moved in a second direction (which may be opposite to the first direction described above; e.g., may be a forward direction), the actuator 210c may cause the first rotor plane “R1” to be inclined at an angle “θ” relative to the floor 104/X-Y plane toward negative Z-axis, and the actuator 210d may cause the second rotor plane “R2” to be inclined at the angle “θ” relative to the floor 104/X-Y plane toward positive Z-axis, as shown in FIG. 5. In some aspects, the angle “θ” may be equivalent to the angle “β”. In other aspects, the angle “θ” may be different from the angle “β”. The angles “β” and “θ” may depend on a plurality of parameters including, but not limited to, a floor inclination, a floor roughness or evenness level, a floor wetness level, first and second rotor speeds (or motor speeds), and/or the like.

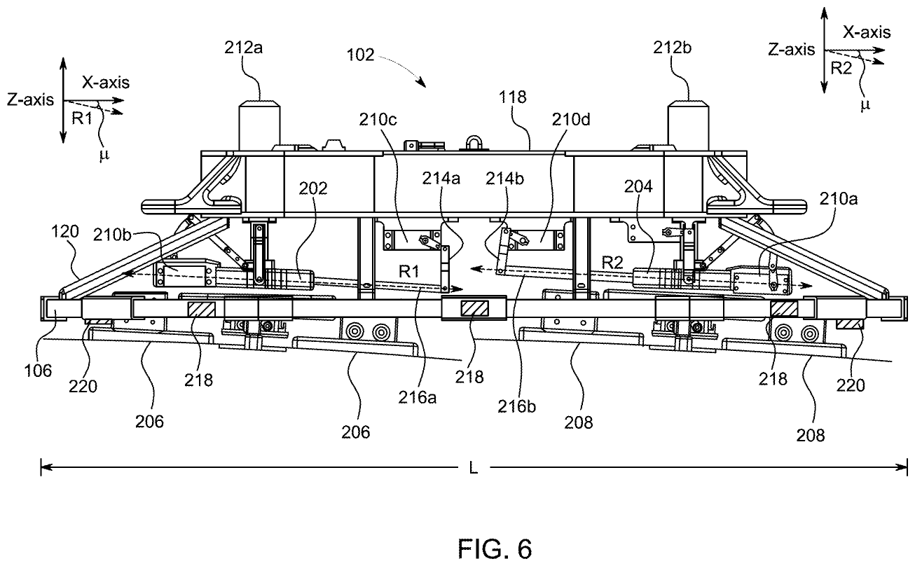

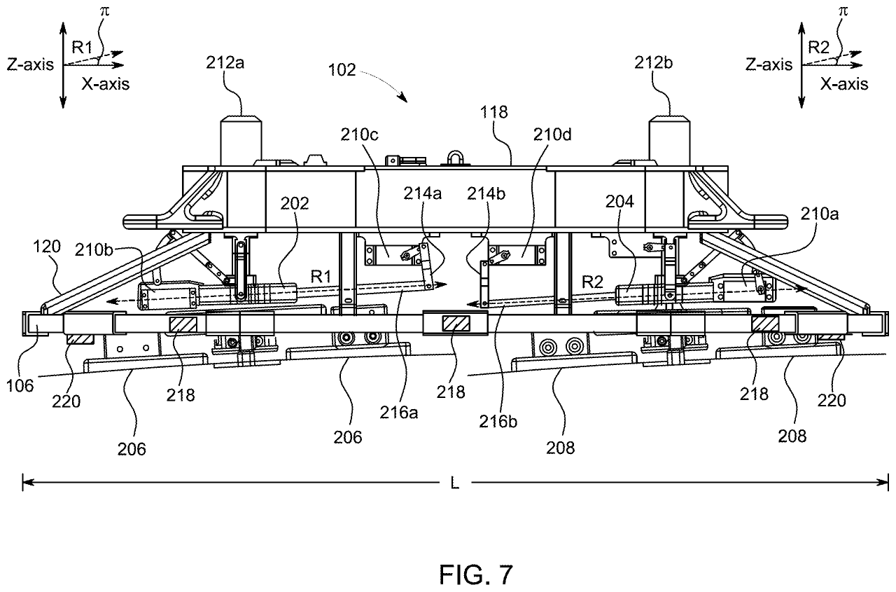

In further aspects, when the system 102 is required to be turned left (as shown in FIG. 6), the actuator 210c may cause the first rotor plane “R1” to be inclined at an angle “μ” relative to the floor 104/X-Y plane toward negative Z-axis, and the actuator 210d may also cause the second rotor plane “R2” to be inclined at the angle “μ” relative to the floor 104/X-Y plane toward negative Z-axis. The angle “μ” may be same as or different from the angles “β” and “θ” described above. In a similar manner, when the system 102 is required to be turned right (as shown in FIG. 7), the actuator 210c may cause the first rotor plane “R1” to be inclined at an angle “π” relative to the floor 104/X-Y plane toward positive Z-axis, and the actuator 210d may also cause the second rotor plane “R2” to be inclined at the angle “π” relative to the floor 104/X-Y plane toward positive Z-axis. The angle “π” may be same as or different from the angles “β”, “θ” and “μ” described above.

A person ordinarily skilled in the art may appreciate from the description above that the system's forward movement, backward movement, and or turn left or right may be caused and controlled by using the actuators 210c, 210d, when the first and second rotors 202, 204 may be rotating (e.g., when the first and second sets of blades 206, 208 may be rotating and be in contact with the floor surface). Similar to the actuators 210a, 210b, the actuators 210c, 210d may also be servo motors that may operate based on command signals obtained from the processor 114, the user device and/or the remote controller.

In some aspects, the actuators 302a, 302b may also be servo motors and may be connected to one of the first rotor 202 or the second rotor 204. In the exemplary aspect depicted in FIG. 3, the actuators 302a, 302b are shown to be connected to the second rotor 204. The actuators 302a, 302b may be configured to cause and control a side-to-side system sliding movement (e.g., left or right sliding movement) based on command signals obtained from the processor 114, the user device and/or the remote controller. The actuators 302a, 302b may work together and mirror each other's movement to enable the system 102 to slide left or right.

As described above, the system 102 may additionally include the sensor unit 108, the transceiver 112, the processor 114 and the memory 116. The sensor unit 108 may include a plurality of sensors that may be disposed on the body 118 and/or the frame 106. The plurality of sensors may include, but is not limited to, cameras, ultrasonic sensors, piezoelectric sensors, proximity sensors, light detection and ranging (lidar) sensors, infrared sensors, and/or the like. In some aspects, at least one sensor (e.g., first sensors 218 shown in FIG. 2) of the sensor unit 108 may be disposed on a frame side surface, and at least one another sensor (e.g., second sensors 220 shown in FIG. 2) of the sensor unit 108 may be disposed on an underside of the frame 106 facing the floor 104 (e.g., when the system 102 rests or moves on the floor 104).

The sensor unit 108 may be configured to detect a concrete floor boundary or a presence of an obstacle on the floor 104 when the system 102 moves on the floor 104. For example, the sensor unit 108 may detect presence of walls 122 or pipes 124 disposed on the walls 122 (or any other obstacle on the floor 104) based on inputs/signals that the first sensors 218 obtain when the system 102 moves on the floor 104 in proximity to the walls 122 or the pipes 124 (or when the frame 106 touches the walls 122 or the pipes 124). Similarly, the sensor unit 108 may detect concrete floor boundaries 126a, 126b based on inputs/signals that the second sensors 220 obtain when the system 102 moves on the floor 104 in proximity to the boundaries 126a, 126b. In this case, the sensor unit 108 may detect the boundaries 126a, 126b when a distance between the second sensors 220 and the surface beneath the system 102 suddenly increases substantially (determined based on the signals obtained from the second sensors 220), indicating that the system 102 may have reached an “end” or an “edge” of the floor 104.

The transceiver 112 may be configured to transmit/receive signals/information/data to/from external devices, e.g., the user device, the remote controller, etc., via the wireless network described above. The memory 116 may store programs in code and/or store data for performing various system operations in accordance with the present disclosure. Specifically, the processor 114 may be configured and/or programmed to execute computer-executable instructions stored in the memory 116 for performing various system functions in accordance with the disclosure. Consequently, the memory 116 may be used for storing code and/or data code and/or data for performing operations in accordance with the present disclosure.

In one or more aspects, the processor 114 may be in communication with one or more memory devices (e.g., the memory 116 and/or one or more external databases (not shown in FIG. 1)). The memory 116 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 116 may be one example of a non-transitory computer-readable medium and may be used to store programs in code and/or to store data for performing various operations in accordance with the present disclosure. The instructions in the memory 116 may include one or more separate programs, each of which may include an ordered listing of computer-executable instructions for implementing logical functions.

In some aspects, the memory 116 may include a plurality of modules and databases including, but not limited to, a user information database 128, a floor information database 130, and a map generation module 132. The map generation module 132, as described herein, may be stored in the form of computer-executable instructions, and the processor 114 may be configured and/or programmed to execute the stored computer-executable instructions for performing system functions in accordance with the present disclosure. The functions associated with the memory modules and databases may be understood in conjunction with the description provided below.

In operation, when a user/contractor desires to finish the floor 104 or smoothen the wet floor 104, the user may place the system 102 on the floor 104. The user may further “switch ON” the system 102 by transmitting an activation command signal to the transceiver 112 via the user device or the remote controller and the wireless network. In some aspects, the system 102 may additionally include a dedicated actuator/button (not shown) that may be activated/pressed by the user to switch ON the system 102.

The transceiver 112 may receive the activation command signal from the user device or the remote controller (or the dedicated actuator/button), and may transmit the activation command signal to the processor 114. The processor 114 may activate a first rotor rotation and a second rotor rotation responsive to obtaining the activation command signal from the transceiver 112. Specifically, the processor 114 may transmit a command signal to the motors housed in the body 118 to cause/activate the first and second rotor rotation, responsive to obtaining (or based on) the activation command signal. As described above, the processor 114 may cause/activate the first and second rotor rotation such that the first rotor 202 and the second rotor 204 axially rotate at the same speed, but in opposite directions.

Responsive to activating the first and second rotor rotation, the processor 114 may transmit command signals to the actuators 210c, 210d to modify/alter the angles between the first and second rotor planes “R1”, “R2” and the floor 104/X-Y plane to cause the system's initial forward/backward movement, and/or left/right turn on the floor 104, as described above. The processor 114 may further transmit command signals to the actuators 302a, 302b to cause the system's initial side-to-side sliding movement. The processor 114 may cause the initial system movement described above to “map” the floor 104, as the system 102 moves on the floor 104. Specifically, when the system 102 may be moving on the floor 104 (responsive to the processor 114 activating the first and second rotor rotation), the processor 114 may obtain inputs from the sensor unit 108. Responsive to obtaining the inputs from the sensor unit 108, the processor 114 may execute the instructions stored in the map generation module 132 to generate a concrete floor two-dimensional (2D) map based on the inputs obtained from the sensor unit 108.

In some aspects, the floor 2D map include location details associated with the walls 122, the pipe 124 (or any other obstacle on the floor 104), the boundaries 126a, 126b, and other floor details including, but not limited to, a floor inclination angle, locations of specific floor areas that may be smooth, or areas that may be uneven, and/or the like. As an example, the floor 104 may include a plurality of areas or floor sub-sections 134a, 134b, 134n (as shown in FIG. 1, collectively referred to as floor sub-sections 134), and the floor 2D map may include location details of each floor sub-section 134, inclination angle of each floor sub-section 134, etc.

The processor 114 may store the generated floor 2D map in the floor information database 130. In addition, the processor 114 may control a first rotor operation and a second rotor operation to cause the system movement on the floor 104 based on the generated floor 2D map. In some aspects, the processor 114 may control the first rotor operation and the second rotor operation based on the generated floor 2D map such that the system 102 moves over the entire area of the floor 104, and the first set of blades 206 and the second set of blades 208 contact and smoothen each floor sub-section of the plurality of floor sub-sections 134. Stated another way, the processor 114 may transmit command signals to the actuators 210c, 210d, 302a, 302b to cause the system's forward/backward movement, right/left side turn, and/or side-to-side sliding movement based on the floor 2D map such that the system 102 covers the entire floor area when the first and second rotors 202, 204, and the first and second sets of blades 206, 208 contact and smoothen all the floor sub-sections 134. In some aspects, the processor 114 may control the first rotor operation and the second rotor operation to cause the system's forward/backward or right/left turn movement on the floor 104 by causing at least one of the actuators 210c or the actuator 210d to modify the angles “β”, “θ”, “μ” or “π”, as described above.

In some aspects, the gyroscope 110 may be configured to determine real-time angle between the first and second rotor planes “R1”, “R2” and the floor 104/X-Y plane when the system 102 moves on the floor 104, and the processor 114 may be configured to control the first rotor operation and the second rotor operation in real-time (i.e., adjust the angles “β”, “θ”, “μ” or “π” in real-time) based on inputs obtained from the gyroscope 110. The inputs from the gyroscope 110 may assist the processor 114 to determine a real-time angle between the first and second rotor planes “R1”, “R2” and the floor 104/X-Y plane, and maneuver system movement (or first and second rotor operation) based on the real-time angle. In a similar manner as described above, the processor 114 may control the first rotor operation and the second rotor operation to cause the side-to-side system sliding movement by activating the actuators 302a, 302b.

In this manner, the processor 114 autonomously controls the system movement based on the generated floor 2D map, to ensure that the system 102 covers the entire floor area without requiring any human intervention.

In further aspects, the processor 114 may control the first rotor operation and the second rotor operation (by transmitting command signals to the actuators 210c, 210d, 302a, 302b) based on the floor 2D map such that the system 102 or the frame 106 does not contact the walls 122 or the pipe 124 (or any other obstacle on the floor 104) when the system 102 moves on the floor 104. In this case, the processor 114 may identify the locations of the walls 122, the pipe 124 (and/or other obstacles) from the floor 2D map, and control the first and second rotor operation such that system/frame contacts with such obstacles are prevented. In some aspects, the processor 114 may further obtain real-time inputs from the sensor unit 108 when the system 102 may be moving on the floor 104, and may maneuver system movement to prevent a contact with an obstacle, when the sensor unit 108 detects the obstacle presence in proximity to the system 102/frame 106. In a similar manner, the processor 114 may control the first rotor operation and the second rotor operation (by transmitting command signals to the actuators 210c, 210d, 302a, 302b) based on the floor 2D map such that the system 102 does not fall off the boundaries 126a, 126b when the system 102 moves on the floor 104. In this case, the processor 114 may retract the system movement (e.g., by causing system's backward movement by using the actuators 210c, 210d) when the system 102 may be getting too close to the boundary 126a/126b.

In additional aspects, the processor 114 may control the first rotor operation and the second rotor operation (by transmitting command signals to the actuators 210c, 210d, 302a, 302b) based on the floor 2D map such that the blades 206, 208 evenly smoothen each floor sub-section 134. Specifically, in this case, the processor 114 may control the first rotor operation and the second rotor operation based on the floor 2D map such that the blades 206, 208 contact and smoothen each floor sub-section 134 for an equivalent time duration, and one floor sub-section is not smoothened for a less (or greater) time duration that the other floor sub-sections.

In this aspect, the processor 114 may first determine locations associated with the plurality of floor sub-sections 134 based on or from the floor 2D map. The processor 114 may then determine a time duration the system 102 spends on each floor sub-section location (e.g., by obtaining inputs from a system timer, not shown) while the first and second rotors 202, 204 rotate, causing the first and second sets of blades 206, 208 to smoothen the floor's sub-section surface. For example, the processor 114 may determine a first time duration that the first and second sets of blades 206, 208 contact and smoothen the floor sub-section 134a and a second time duration that the first and second sets of blades 206, 208 contact and smoothen the floor sub-section 134b, when the system 102 moves on the floor 104. The processor 114 may control the first rotor operation and the second rotor operation (by transmitting command signals to the actuators 210c, 210d, 302a, 302b) such that the first time duration becomes equivalent to the second time duration. For example, if the first and second sets of blades 206, 208 spend three minutes contacting and smoothening the floor sub-section 134a, the processor 114 may control the first rotor operation and the second rotor operation such that the first and second sets of blades 206, 208 spend three minutes contacting and smoothening the floor sub-section 134b (and other floor sub-sections associated with the floor 104).

In further aspects, in addition or alternative to determining the time duration described above, the processor 114 may determine a count of passes or rotations that the blades 206, 208 perform on each floor sub-section 134, and ensure that the count of passes is equivalent for all floor sub-sections 134. In additional aspects, the processor 114 may determine an optimal time duration and/or count of passes for each floor sub-section 134 based on the hardness level of the concrete surface (as determined via the sensor unit 108), and may control the system operation such that the blades 206, 208 spend the optimal time duration on the floor sub-section 134 and/or pass the floor sub-section 134 for the determined optimal number of times.

The processor 114 may be further configured to adjust/modify the blade pitch, such that the floor 104 is smoothened according to the user's preferences and/or inputs, when the first and second sets of blades 206, 208 contact and smoothen the floor surface (e.g., when the first and second rotors 202, 204 rotate). In this case, the transceiver 112 may first receive the user preferences or user inputs associated with a desired floor smoothness level, a desired floor shine level, and/or the like, from the user device or the remote controller. In some aspects, the user preferences or user inputs may also be associated with a user desired angle “a” between the blade lateral axis “Wb” and the first and second rotor planes “R1”, “R2”, or the user desired blade pitch. Responsive to receiving the user preferences or user inputs, the transceiver 112 may transmit the user preferences or user inputs to the processor 114, and to the user information database 128 for storage purpose.

The processor 114 may obtain the user preferences or the user inputs from the transceiver 112 or the user information database 128. Responsive to obtaining the user preferences/inputs, the processor 114 may cause the actuators 210a, 210b to modify/adjust the angle “a” between the blade lateral axis “Wb” and the first and second rotor planes “R1”, “R2” based on the user preferences/inputs. Stated another way, the processor 114 may cause the actuators 210a, 210b to adjust the blade pitch based on the user preferences/inputs. The blade pitch may be adjusted based on an extent to which the user may desire the floor 104 to be smooth and/or shiny.

In further aspects, the processor 114 may cause the actuators 210a, 210b to adjust the blade pitch based on real-time concrete floor characteristics (in addition to or alternative to the user preferences/inputs). In an exemplary aspect, the real-time concrete floor characteristics may include, but are not limited to, a real-time concrete floor smoothness level, a real-time concrete floor wetness level, and/or the like. In this case, the processor 114 may determine the real-time concrete floor characteristics based on inputs obtained from the sensor unit 108, and may cause the actuators 210a, 210b to modify/adjust the angle “a” between the blade lateral axis “Wb” and the first and second rotor planes “R1”, “R2” (i.e., adjust the blade pitch) based on the real-time concrete floor characteristics. In some aspects, the processor 114 may further transmit command signals to the motors housed in the body 118 to control/adjust a first rotor rotational speed and a second rotor rotational speed based on the real-time concrete floor characteristics. For example, the processor 114 may reduce the first and second rotor rotational speed when the real-time concrete floor characteristics indicate that the floor 104 may be wet, and may increase the first and second rotor rotational speed when the real-time concrete floor characteristics indicate that the floor 104 may be dry. In additional aspects, the processor 114 may control a time duration the first and second sets of blades 206, 208 spend on a specific floor sub-section 134 (to smoothen the floor sub-section 134) based on the real-time concrete floor characteristics and/or the user preferences/inputs.

The system 102 may include one or more additional components/unit not described above and not shown in FIGS. 1-7, 8A, 8B, which may further enhance user's ease of operating the system 102. For example, the system 102 may include one or more batteries configured to store and power the system components/units descried above, one or more light emitting diodes (LEDs), sound or alarm systems, and/or the like. The system 102 may be further configured to transmit, via the transceiver 112 and the wireless network, real-time system operating details (e.g., rotor rpm, blade pitch, system run time, real-time battery state of charge, etc.) to the user device for user's reference.

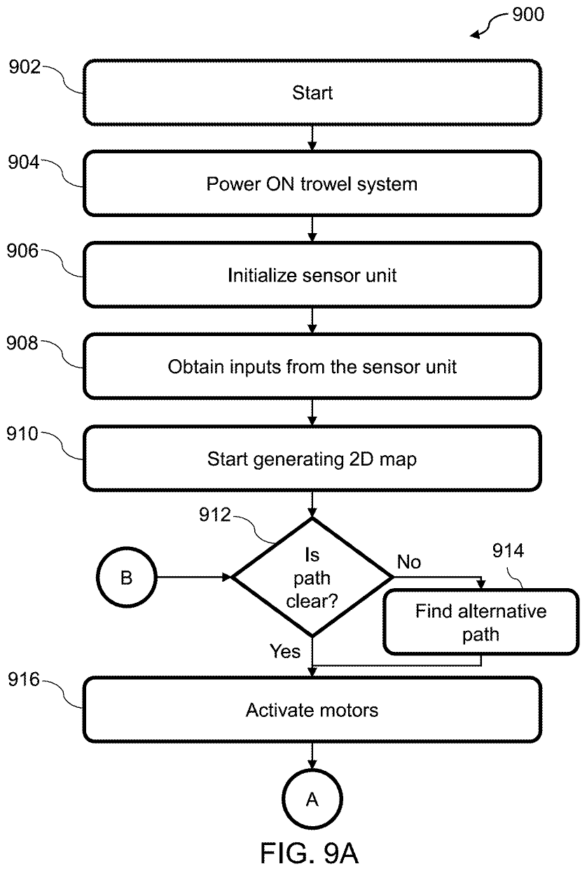

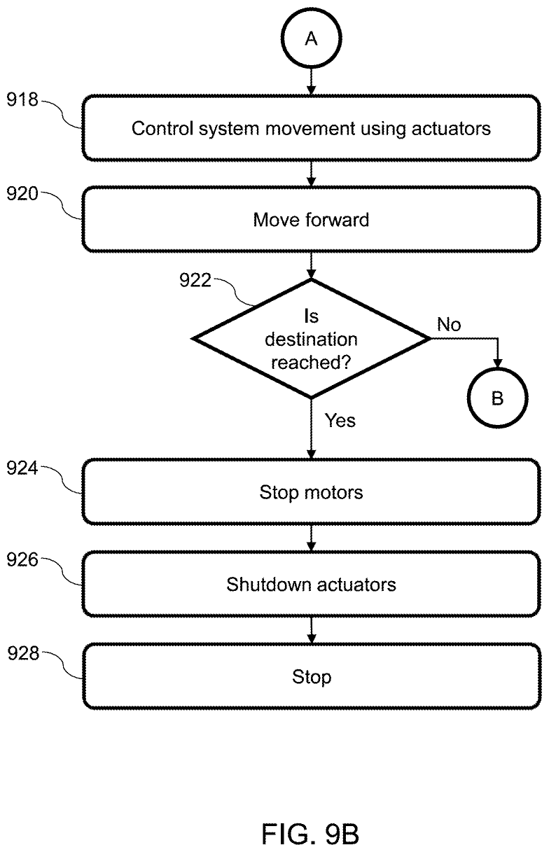

FIGS. 9A and 9B depict a flow diagram of an example trowel method 900 for finishing the floor 104 in accordance with the present disclosure. FIGS. 9A and 9B may be described with continued reference to prior figures, including FIGS. 1-7, 8A and 8B. The following process is exemplary and not confined to the steps described hereafter. Moreover, alternative embodiments may include more or less steps than are shown or described herein and may include these steps in a different order than the order described in the following example embodiments.

Referring to FIGS. 9A and 9B, at step 902, the method 900 may commence. At step 904, the method 900 may include powering ON, by the processor 114 or the user, the system 102. At step 906, the method 900 may include initializing, by the processor 114, the sensor unit 108. At step 908, the method 900 may include obtaining, by the processor 114, the inputs from the sensor unit 108.

At step 910, the method 900 may include starting to generate, by the processor 114, the floor 2D map. At step 912, the method 900 may include determining, by the processor 114, whether the path is clear for the system 102 to move. If the processor 114 determines that the path is not clear, then at step 914, the processor 114 finds/identifies an alternative (and clear) path.

At step 916, the method 900 may include activating, by the processor 114, the motors (e.g., the electric brushless motors that drive the rotors 202, 204) when the path is clear. At step 918, the method 900 may include controlling, by the processor 114, the system movement using the actuators/servo motors, as described above. At step 920, the method 900 may include causing, by the processor 114, the system 102 to move forward.

At step 922, the method 900 may include determining, by the processor 114, whether a destination point is reached by the system 102. The method 900 may move back to the step 912 if the destination point is not reached. On the other hand, if the destination point is reached, the method 900 moves to step 924.

At the step 924, the method 900 may include stopping, by the processor 114, the motors. At step 926, the method 900 may include shutting down, by the processor 114, the actuators or the servo motors.

At step 928, the method 900 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A trowel system for finishing a concrete floor, the trowel system comprising:
a first rotor and a second rotor configured to axially rotate at a same speed in opposite directions;
a sensor unit configured to detect a concrete floor boundary or a presence of an obstacle on the concrete floor when the trowel system moves on the concrete floor; and
a processor configured to:
activate a first rotor rotation and a second rotor rotation;
obtain inputs from the sensor unit responsive to activating the first rotor rotation and the second rotor rotation;
generate a concrete floor two-dimensional (2D) map based on the inputs obtained from the sensor unit; and
control a first rotor operation and a second rotor operation to cause a trowel system movement on the concrete floor based on the concrete floor 2D map.

2. The trowel system of claim 1, wherein the processor activates the first rotor rotation and the second rotor rotation based on a command signal received from a user device or a remote controller.

3. The trowel system of claim 1 further comprising a first set of blades attached to the first rotor and a second set of blades attached to the second rotor, wherein the first set of blades and the second set of blades are configured to:
rotate when the first rotor and the second rotor rotate; and
contact and smoothen a concrete floor surface when the first set of blades and the second set of blades rotate.

4. The trowel system of claim 3, wherein the concrete floor comprises a plurality of floor sections, and wherein the processor is further configured to:
determine locations associated with the plurality of floor sections based on the concrete floor 2D map;
determine a first time duration the first set of blades and the second set of blades contact and smoothen a first floor section of the plurality of floor sections when the trowel system moves on the concrete floor;
determine a second time duration the first set of blades and the second set of blades contact and smoothen a second floor section of the plurality of floor sections when the trowel system moves on the concrete floor; and
control the first rotor operation and the second rotor operation such that the first time duration becomes equivalent to the second time duration.

5. The trowel system of claim 4, wherein the processor is further configured to control the first rotor operation and the second rotor operation such that the first set of blades and the second set of blades contact and smoothen each floor section of the plurality of floor sections.

6. The trowel system of claim 3, wherein each blade of the first set of blades and the second set of blades comprises a rectangular plate or an elongated oval shaped plate.

7. The trowel system of claim 6, wherein a first blade longitudinal axis of each first blade of the first set of blades is parallel to a first rotor plane, and wherein a second blade longitudinal axis of each second blade of the second set of blades is parallel to a second rotor plane.

8. The trowel system of claim 7 further comprising a first actuator connected to the first rotor and a second actuator connected to the second rotor, wherein the first actuator is configured to control a first angle between a first blade lateral axis of each first blade of the first set of blades and the first rotor plane, and wherein the second actuator is configured to control a second angle between a second blade lateral axis of each second blade of the second set of blades and the second rotor plane.

9. The trowel system of claim 8, wherein the processor is further configured to:
obtain user inputs from a user device or a remote controller; and
cause the first actuator to modify the first angle and the second actuator to modify the second angle based on the user inputs.

10. The trowel system of claim 8, wherein the processor is further configured to:
determine real-time concrete floor characteristics based on the inputs obtained from the sensor unit; and
cause the first actuator to modify the first angle and the second actuator to modify the second angle based on the real-time concrete floor characteristics.

11. The trowel system of claim 10, wherein the real-time concrete floor characteristics comprise one or more of a concrete floor smoothness level and a concrete floor wetness level, and wherein the processor is further configured to control a first rotor rotational speed and a second rotor rotational speed based on the real-time concrete floor characteristics.

12. The trowel system of claim 1, wherein the trowel system is configured to move on the concrete floor when the first rotor and the second rotor rotate, and when at least one of a first rotor plane or a second rotor plane is inclined at a non-zero angle relative to the concrete floor.

13. The trowel system of claim 12 further comprising a third actuator connected with the first rotor and a fourth actuator connected with the second rotor, wherein the third actuator is configured to control a third angle between the first rotor plane and the concrete floor, and wherein the fourth actuator is configured to control a fourth angle between the second rotor plane and the concrete floor.

14. The trowel system of claim 13, wherein the processor controls the first rotor operation and the second rotor operation to cause a trowel system forward, backward or turn movement on the concrete floor by causing at least one of the third actuator to modify the third angle or the fourth actuator to modify the fourth angle.

15. The trowel system of claim 14 further comprising a gyroscope configured to determine the third angle and the fourth angle, wherein the processor is further configured to control the first rotor operation and the second rotor operation based on inputs obtained from the gyroscope.

16. The trowel system of claim 14 further comprising a fifth actuator and a sixth actuator connected to the first rotor, wherein the fifth actuator and the sixth actuator are configured to control a side-to-side trowel system sliding movement, and wherein the processor controls the first rotor operation and the second rotor operation to cause the side-to-side trowel system sliding movement by activating the fifth actuator and the sixth actuator.

17. The trowel system of claim 1, wherein the sensor unit comprises one or more of a camera, an ultrasonic sensor, a piezoelectric sensor, a proximity sensor, a light detection and ranging (lidar) sensor, or an infrared sensor.

18. The trowel system of claim 17 further comprising a frame, wherein a first sensor associated with the sensor unit is disposed at a frame side surface, and wherein a second sensor associated with the sensor unit is disposed on an underside of the frame facing the concrete floor.

19. A trowel system for finishing a concrete floor, the trowel system comprising:
a first rotor and a second rotor configured to axially rotate at a same speed in opposite directions;
a first set of blades attached to the first rotor and a second set of blades attached to the second rotor, wherein the first set of blades and the second set of blades are configured to:
rotate when the first rotor and the second rotor rotate; and
contact and smoothen a concrete floor surface when the first set of blades and the second set of blades rotate;
a sensor unit configured to detect a concrete floor boundary or a presence of an obstacle on the concrete floor when the trowel system moves on the concrete floor; and
a processor configured to:
activate a first rotor rotation and a second rotor rotation;
obtain inputs from the sensor unit responsive to activating the first rotor rotation and the second rotor rotation;
generate a concrete floor two-dimensional (2D) map based on the inputs obtained from the sensor unit; and
control a first rotor operation and a second rotor operation to cause a trowel system movement on the concrete floor based on the concrete floor 2D map.

20. A trowel system for finishing a concrete floor, the trowel system comprising:
a frame;
a first rotor and a second rotor configured to axially rotate at a same speed in opposite directions;
a sensor unit configured to detect a concrete floor boundary or a presence of an obstacle on the concrete floor when the trowel system moves on the concrete floor, wherein a first sensor associated with the sensor unit is disposed at a frame side surface, and wherein a second sensor associated with the sensor unit is disposed on an underside of the frame facing the concrete floor; and
a processor configured to:
activate a first rotor rotation and a second rotor rotation;
obtain inputs from the sensor unit responsive to activating the first rotor rotation and the second rotor rotation;
generate a concrete floor two-dimensional (2D) map based on the inputs obtained from the sensor unit; and
control a first rotor operation and a second rotor operation to cause a trowel system movement on the concrete floor based on the concrete floor 2D map.
